(19) United States
(12) Patent Application Publication
(10) Pub. No.: US 2012/0206220 A1
(43) Pub. Date: Aug. 16, 2012

(54) ELECTROMAGNETIC SWITCH DEVICE

(75) Inventors: Masami NIIMI, Handa-shi (JP); Mitsuhiro MURATA, Niwa-gun (JP); Takahisa INAGAKI, Nishio-shi (JP)

(73) Assignee: DENSO CORPORATION, KARIYA-CITY (JP)

(21) Appl. No.: 13/365,550

(22) Filed: Feb. 3, 2012

(30) Foreign Application Priority Data
Feb. 10, 2011 (JP) 2011-026628

(51) Int. Cl. H01H 3/22

(52) U.S. Cl. 335/71

(57) ABSTRACT

In an electromagnetic switch, a magnetic plate, which forms a part of a magnetic circuit, and a bobbin of a second coil are assembled as one body by insert molding. An outer circumferential surface of the magnetic plate is adhered to an inner circumferential surface of a cylindrical frame made of metal. Because a large amount of heat energy generated in the second coil is transmitted to the magnetic plate, this can discharge the heat energy through the magnetic plate to the cylindrical flame. Because a mounting surface of the cylindrical frame is fixed to an end part of a starter housing case, it is possible to easily discharge the heat energy generated in the second coil through the cylindrical frame to the starter housing case. This structure prevents a temperature rise of the second coil and contributes entire-size reduction of the electromagnetic switch.

### CROSS-REFERENCE TO RELATED APPLICATION

This application is related to and claims priority from Japanese Patent Application No. 2011-026628 filed on Feb. 10, 2011, the contents of which are hereby incorporated by reference.

### BACKGROUND OF THE INVENTION

1. Field of the Invention

The present invention relates to electromagnetic switch devices for use in starters of motor vehicles, in which a primary solenoid and a secondary solenoid are arranged in the inside of a single cylindrical frame along an axial direction of the electromagnetic switch.

2. Description of the Related Art

There is a conventional electromagnetic switch device for use in a starter device of a motor vehicle, for example, which is disclosed in Japanese patent laid open publication No. JP 2009-191843. In general, an electromagnetic switch device has a primary solenoid and a secondary solenoid. The primary solenoid moves a drive pinion of a starter device toward a ring gear side of an internal combustion engine of a motor vehicle. The secondary solenoid turns on and off a current supply to the starter motor in the starter device. In particular, the primary solenoid and the secondary solenoid are assembled to form a single solenoid unit. The single solenoid unit is accommodated in a single cylindrical frame. However, because the primary solenoid and the secondary solenoid are arranged in the solenoid unit along an axial direction of the electromagnetic switch device, this structure increases the entire size or the total length of the electromagnetic switch device.

The conventional electromagnetic switch device, for example, disclosed in Japanese patent laid open publication No. JP 2009-191843, has a unique structure using a common stationary iron core, in which the operation direction of the primary solenoid faces the operation direction of the secondary solenoid, that is, the direction along which a movable iron core of the primary solenoid is attracted to the common stationary iron core faces the direction along which a movable iron core of the secondary solenoid is attracted to the common stationary iron core. This structure makes it possible to decrease the entire size or the total length of the conventional electromagnetic switch device.

However, the structure of the conventional electromagnetic switch device disclosed in Japanese patent laid open publication No. JP 2009-191843 is difficult to decrease the length of the coil along the axial direction of the electromagnetic switch because the coil occupies a large part of the entire length of the electromagnetic switch device. In other words, decreasing the length of the coil contributes the downsizing of the entire length of the electromagnetic switch.

### SUMMARY

It is therefore desired to provide an electromagnetic switch device having a primary solenoid and a secondary solenoid which are accommodated in a cylindrical frame, and arranged along an axial direction of the electromagnetic switch device.

An exemplary embodiment provides an electromagnetic switch for use in a starter motor. The electromagnetic switch has a cylindrical frame, a resin cover case and a solenoid unit. The cylindrical frame is made of metal and has a mounting surface at one axial end part of the cylindrical frame and an opening part at the other axial end surface of the cylindrical frame. The mounting surface is mounted to a starter housing case. The resin cover case is mounted to and fixed to the opening part of the cylindrical frame. The cylindrical frame is closed with the resin cover. The solenoid unit has a primary solenoid and a secondary solenoid. The primary solenoid has a first coil magnetized when a current flows in the first coil. The magnetized first coil attracts a drive pinion to a ring gear of an internal combustion engine side. The secondary solenoid has a second coil magnetized when a current flows in the second coil. The secondary solenoid turns on and off a main switch in order to allow and inhibit a current to flow in a starter motor according to an excitation state of the second coil. In the electromagnetic switch, the primary solenoid is arranged in the cylindrical frame at the mounting surface side of the cylindrical frame. The secondary solenoid is arranged in the cylindrical frame at the resin cover side so that the primary solenoid and the secondary solenoid are arranged in series along an axial direction of the electromagnetic switch, and assembled as one body. The secondary solenoid has a magnetic plate made of metal which forms a part of a magnetic circuit and is arranged adjacent to the resin cover side in the axial direction of the bobbin made of resin on which the second coil is wound, and the magnetic plate is arranged perpendicular to the axial direction of the second coil. The outer circumferential surface of the magnetic plate in the radial direction is adhered to in full contact with the inner circumferential surface of the cylindrical frame.

In particular, the magnetic plate made of metal, which forms a part of the magnetic circuit, is arranged adjacent to the bobbin of the second coil, and the outer circumferential surface of the magnetic plate is adhered to in full contact with the inner circumferential surface of the cylindrical frame. This improve structure makes it possible to transmit a large amount of heat energy generated in the second coil to the magnetic plate adhered to in full contact with the bobbin and to discharge the heat energy generated in the second coil to the cylindrical frame made of metal through the magnetic plate with high efficiency.

Further, because the mounting surface formed at one axial end of the cylindrical frame is adhered and fixed to the end surface of the starter housing case having a large heat capacity, this can allow heat energy to be easily discharged from the cylindrical frame to the starter housing case. As a result, it is possible to easily discharge heat energy generated in the second coil to the starter housing case with high efficiency. This can suppress temperature rise of the second coil, and decrease the total size of the second coil. Still further, because this structure can decrease the axial length of the second coil, it is possible to decrease the entire size of the electromagnetic switch.

### BRIEF DESCRIPTION OF THE DRAWINGS

A preferred, non-limiting embodiment of the present invention will be described by way of example with reference to the accompanying drawings, in which:

FIG. 1 is a view showing a cross section of an electromagnetic switch device according to a first exemplary embodiment of the present invention;

FIG. 2 is a side view of a starter equipped with the electromagnetic switch device shown in FIG. 1;

FIG. 3 is a view showing a cross section of a second coil of a secondary solenoid in the electromagnetic switch device according to the first exemplary embodiment and showing a conduction of heat generated in the second coil;

FIG. 4 is a graph showing a comparison result of temperature rise between the electromagnetic switch device according to the exemplary embodiment of the present invention and a conventional electromagnetic switch device; and

FIG. 5 is a view showing a cross section of a second coil of the secondary solenoid in the electromagnetic switch device according to a second exemplary embodiment and showing a heat flow generated in the second coil.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### First Exemplary Embodiment

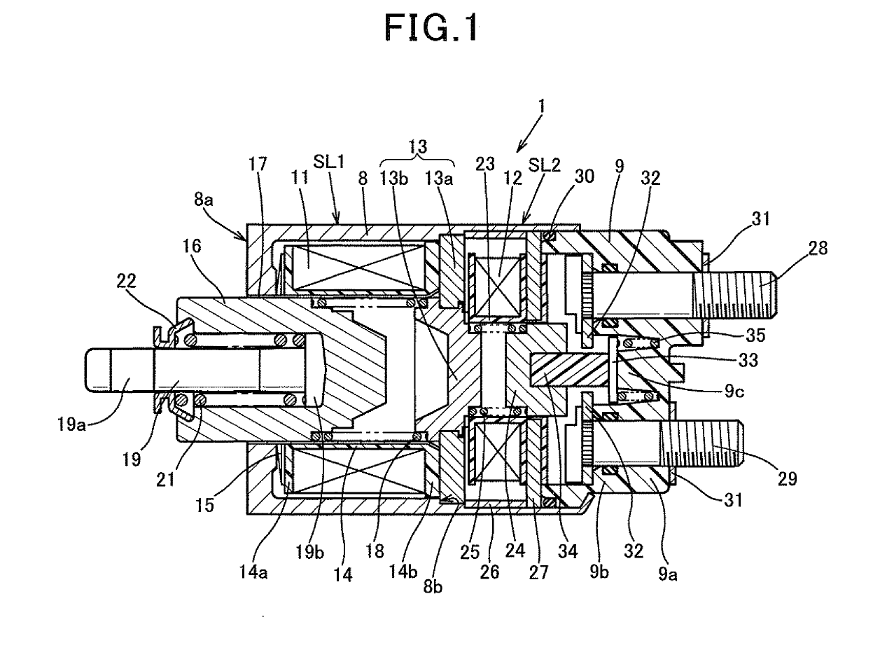

A description will be given of an electromagnetic switch device according to a first exemplary embodiment of the present invention with reference to FIG. 1 to FIG. 4.

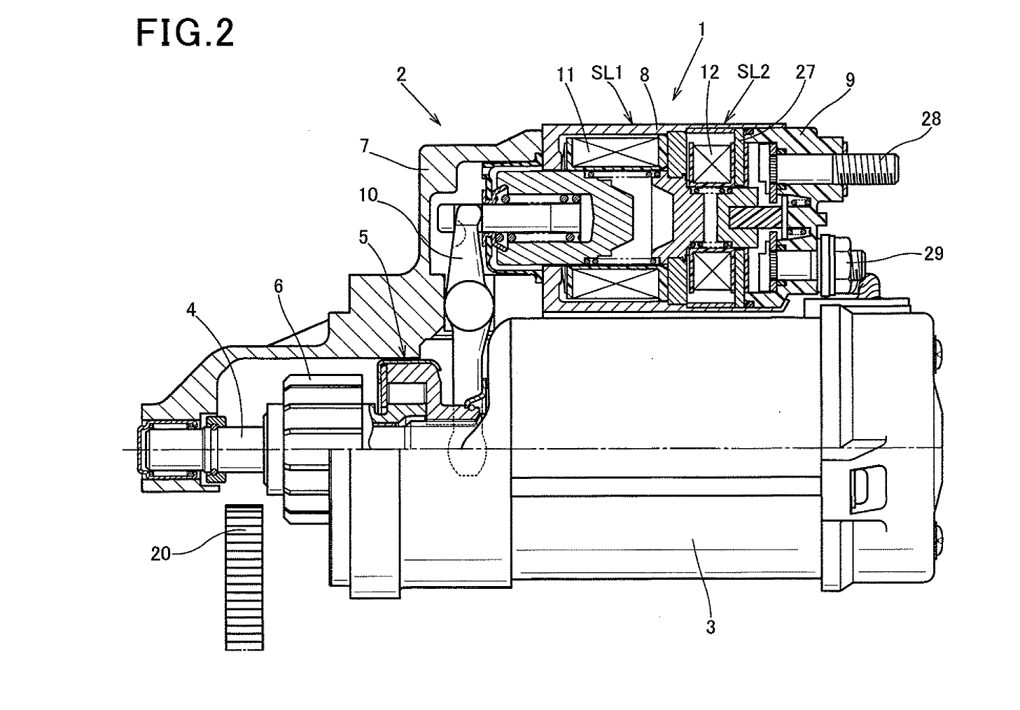

FIG. 1 is a view showing a cross section of the electromagnetic switch device 1 according to the first exemplary embodiment of the present invention. FIG. 2 is a side view of an engine starter 2 equipped with the electromagnetic switch device 1 shown in FIG. 1.

The electromagnetic switch device 1 according to the first exemplary embodiment is applied to the engine starter 2 shown in FIG. 2 which is mounted to a motor vehicle with idling stop function. The idling stop function controls an automatic engine stop and a restart of the internal combustion engine mounted to a motor vehicle. For example, the idling stop function automatically stops the fuel supply to the internal combustion engine when the motor vehicle temporarily stops, for example, at a traffic signal on an intersection or before a traffic jam. The idling stop function automatically restarts the engine starter 2 in order to restart the internal combustion engine when the driver of the motor vehicle releases his foot from the brake pedal or operates the shift gear lever to switch the current gear position such as a stop position into a drive gear position and when a predetermined engine restart condition is satisfied.

As shown in FIG. 2, the main structure of the engine starter 2 other than the electromagnetic switch device 1 has a known structure in which a rotary torque generated in the stator motor 3 is amplified by a deceleration device (not shown) and the amplifier rotary torque is transmitted to an output shaft 4, and the amplified rotary torque is transmitted to a drive pinion 6 of the starter motor 3 through a clutch assembly 5. The clutch assembly 5 is fixed to an outer circumferential surface of the output shaft 4. That is, because the structure of the starter 2 excepting the electromagnetic switch device 1 is a known structure, the explanation of the structure of the starter 2 is omitted here. The structure and features of the electromagnetic switch device 1 according to the first exemplary embodiment will be explained in detail.

A description will now be given of the structure of the electromagnetic switch device 1 according to the first exemplary embodiment with reference to FIG. 1.

The electromagnetic switch device 1 has a cylindrical frame 8 and a resin cover case 9. The cylindrical frame 8 has a mounting surface 8a which is formed at one end surface of the cylindrical frame 8, through which the electromagnetic switch device 1 is mounted to a starter housing case 7 (see FIG. 2). The cylindrical frame 8 is made of metal and has an opening part which is opposite in arrangement position to the mounting surface 8a side. A solenoid unit (which will be explained later in detail) is inserted into the inside of the cylindrical frame 8. The resin cover case 9 is fitted to the opening part of the cylindrical frame 8 to close the cylindrical frame 8 from the outside. The resin cover case 9 is fixed to the cylindrical frame 8. A round hole is formed at a central part in the mounting surface 8a. The cylindrical frame 8 is tightly fixed to the starter housing case 7 through two stud bolts (not shown). The stud bolts are inserted to the parts which are the outside from the round hole formed at the central part of the mounting surface 8a.

The cylindrical frame 8 has the same outer diameter observed from one end part at the mounting surface 8a side to the other end part at which the opening part is formed. The other end part is larger in internal diameter size than the other end part of the cylindrical frame 8. That is, the thickness of the inner diameter at one end part is larger than that of the other end part of the cylindrical frame 8, and a step part 8b is formed in the inner circumferential surface f the cylindrical frame 8.

The solenoid unit is composed of a primary solenoid SL1 and a secondary solenoid SL2. The primary solenoid SL1 drives the shift gear lever 10 (see FIG. 2) and moves the drive pinion 6 with the clutch 5 toward the opposite direction of the starter motor 3 (toward the left direction shown in FIG. 2). The secondary solenoid SL2 turns on and off the main switch (which will be explained later) in a motor circuit. The motor circuit is a current circuit to flow a current into the starter motor 3 from a battery (not shown). The main switch allows the current to flow and interrupt into the starter motor 3 from the battery to flow and interrupt.

The primary solenoid SL1 has a first coil 11. The secondary solenoid SL2 has a second coil 12. The first coil 11 generates magnetic force when an electric current flows through the first coil 11. Like the first coil 11, the second coil 12 also generates magnetic force when an electric current flows in the second coil 12. A common stationary core 13 is placed between the first coil 11 and the second coil 12. The common stationary core 13 is composed of a ring-shaped iron core plate part 13a and an iron core part 13b. The iron core part 13b is pressed into and fitted to the inner circumferential part of the ring-shaped iron core plate part 13a. An outer circumferential surface as one end part of the ring-shaped iron core plate part 13a is in contact with the step part 8b formed in the inner circumferential surface of the cylindrical frame 8. This positions the ring-shaped iron core plate part 13a to the mounting surface of the cylindrical frame 8.

The first coin is wound around a bobbin 14 made of resin in the primary solenoid SL1. The primary solenoid SL1 is accommodated in one end part (at the side of the mounting surface 8a) of the cylindrical frame 8. An elastic member 15 (for example, which is composed of a plate spring, rubber. etc.) is placed between one flange part 14a of the bobbin 14 and the mounting surface 8a of the cylindrical frame 8. The other flange part 14b of the bobbin 14 is pressed to the ring-shaped iron core plate part 13a by elastic force generated by the elastic member 15. This makes it possible to limit the movement of the primary solenoid SL1 along the axial direction of the rotor 1.

A plunger 16 is arranged in the inside of the first coil 11, namely, placed in the inner circumference part. The plunger 16 is moved along the axial direction which is the forward direction and the opposite direction to the side of the attraction surface (at the left side) of the iron core plate 13b. A cylindrical sleeve 17 is inserted to and fixed to the inside of the bobbin 14. The sleeve 17 guides the movement of the plunger 16.

When a current is supplied to the first coil 11 and the common stationary core 13 is magnetized, the plunger 16 is attracted to one attraction surface of the iron core part 13b against the force of a return spring 18. This return spring 18 is arranged between the iron core part 13b and the plunger 16.

When the current supply to the first coil 11 is stopped, the plunger 16 is returned to its original position (toward the left side direction shown in FIG. 1) by the spring force of the return spring 18.

The plunger 16 has an approximate cylindrical shape and has a cylindrical hole at the central part thereof in the radius direction. The cylindrical hole formed at the central part is opened at one end surface (the left side shown in FIG. 1) of the plunger 16. The other end surface of the plunger 16 is closed. A joint 19 and a drive spring 21 are inserted into the inside of the cylindrical hole of the plunger 16. Through the joint the motion of the plunger 16 is transmitted to the shift gear lever 10. The drive spring provides a counter force against the force with which the drive pinion 6 is engaged with the ring gear 20 (see FIG. 2) of the internal combustion engine.

The joint 19 has a bar shape (or a rod shape). The joint 19 has an engagement groove 19a formed at one end part which is extended from the cylindrical hole of the plunger 16 when the joint 19 is inserted into the inside of the cylindrical hole of the plunger 16. One end part of the shift gear lever 10 is engaged with the engagement groove 19a of the joint 19 together. The joint 19 has a flange part 19b formed at the other end part thereof. The flange part 19b has a diameter in order to slide the joint 19 in the inside of the cylindrical hole of the plunger 16. The flange part 19b of the joint 19 is forcedly pressed to the bottom surface of the cylindrical hole of the plunger 16 by the drive spring 21.

The drive spring 21 is arranged between a washer 22 and the flange part 19b of the joint 19. As shown in the left side in FIG. 1, the washer 22 is caulked at the opening end part of the plunger 16 to tightly fix it to the plunger 16.

When the plunger 16 is attracted and moved to the iron core part 13b, the washer 22 is compressed and accumulates the compressed force which acts as counterforce during the period in which the plunger 16 is attracted to and reaches the attraction surface of the iron core part 13b after the end surface part of the drive pinion 6 is in contact with the end surface of the ring gear 20, in which the drive pinion 6 is pressed along the axial direction toward the direction opposite to the starter motor 3 side by the operation of the shift gear lever 10.

The second coil 12 of the secondary solenoid SL2 is wound around a bobbin 23 made of resin. The secondary solenoid SL2 is accommodated in the inside at the other end part (which is opposite to the mounting surface 8a side) of the cylindrical frame 8.

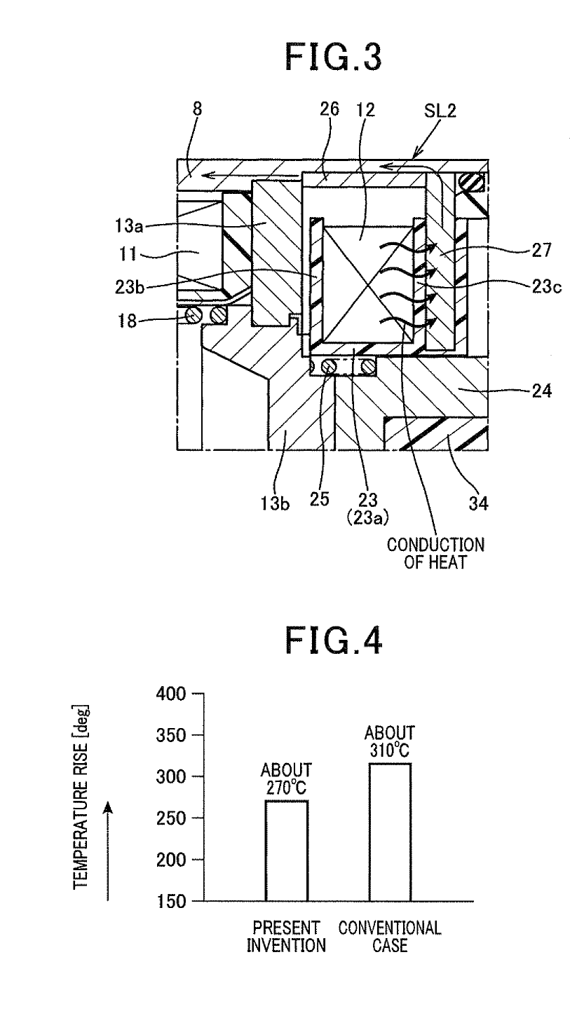

FIG. 3 is a view showing a cross section of the second coil 12 of the secondary solenoid SL2 in the electromagnetic switch device according to the first exemplary embodiment and showing the flow of heat (or a conduction of heat) generated in the second coil 12. As shown in FIG. 3, the bobbin 23 has a cylindrical body part 23a and a pair of flange parts 23b and 23c. The flange parts 23b and 23c are formed along the axial direction at the end parts of the cylindrical body part 23a, respectively. The second coil is wound around the bobbin 23 so that an entire surface area of side parts of the second coil 12 is greater than a surface area of the part of the second coil 12 which is in contact with the outer circumferential surface of the cylindrical body part 23a.

A movable iron core 24 is arranged in the inside of the second coil 12. The movable iron core 24 is moved along the axial direction of the electromagnetic switch device 1 against the other attraction surface (at the right side surface of the iron core part 13b shown in FIG. 1) of the iron core part 13b of the common stationary core 13.

When a current is supplied to the second coil 12 and the common stationary core 13 is magnetized, the movable iron core 24 is attracted to the other attraction surface of the iron core part 13b against the force generated by the return spring 25 placed between the movable iron core 24 and the iron core part 13b. When the current supply to the second coil 12 is stopped, the movable iron core 24 is returned toward the direction (toward the right side direction shown in FIG. 1) which is opposite to the iron core part 13b.

As shown in FIG. 1, a cylindrical supplemental yoke 26 is arranged at the outside radial direction of the second coil 12. A magnetic plate 27 is arranged at the surface of the bobbin 23 which is opposite to the ring-shaped iron core plate part 13a observed along the axial direction of the secondary solenoid SL2.

The supplemental yoke 26 is inserted into the inside of the other end part of the cylindrical frame 8. The other end part (at the secondary solenoid SL2 side) of the cylindrical frame 8 is thinner than one end part (at the primary solenoid SL1 side) of the cylindrical frame 8. The end surface of the supplemental yoke 26 is in contact with the surface (at the right side shown in FIG. 1) of the ring-shaped iron core plate part 13a, when observed from the axial direction. This positions the supplemental yoke 26 to the ring-shaped iron core plate part 13a along the axial direction.

The magnetic plate 27 and the bobbin 23 are assembled to an integrated single body by insert molding, as shown in FIG. 3. This makes it possible to avoid an air layer between the flange part 23c of the bobbin 23 and the magnetic plate 27 from being formed. This flange part 23c of the bobbin 23 supports the side surface of the second coil 12 (which is the opposite side of the ring-shaped iron core plate part 13a). In other words, the flange part 23c of the bobbin 23 is tightly in contact with the magnetic plate 27 without any clearance or an air layer.

Further, as shown in FIG. 3, the end surface of the magnetic plate 27, (at the end part of the second coil 12 in the outer radius direction) is in contact with the end part of the supplemental yoke 26 at the outer circumferential part observed in the radius direction. Further, the magnetic plate 27 is positioned along the axial direction against the supplemental yoke 26. Still further, the outer circumferential surface of the magnetic plate 27 is tightly in contact with the inner circumferential surface of the cylindrical frame 8. In order to compensate a loss due to decreasing a rough contact surface area between the magnetic plate 27 and the cylindrical frame 8, it is preferable to have a structure in which the outer diameter size of the magnetic plate 27 is larger than that of the inner diameter of the cylindrical frame 8, and the magnetic plate 27 is forcedly inserted into the inside of the cylindrical frame 8.

The magnetic plate 27 is generally produced by a press machine with punching. However, usual press generates a broken surface at the outer circumferential surface of the magnetic plate 27. This decreases the shear surface of the magnetic plate 27. In order to keep the contact area with the cylindrical frame 8, it is possible to execute an additional process to cut the magnetic plate 27. However, the additional process leads to increase the production cost. The present invention uses a machine for executing fine blanking process which is capable of processing a work piece in order to obtain a smooth sheared surface with high accuracy and to obtain a large contact area.

The resin cover case 9 is composed of a base surface 9a and a cylindrical leg part 9b. Two bolts 28 and 29 are inserted into and fastened to the base part 9a of the resin cover case 9. The cylindrical led part 9b extends from the outer circumferential part of the base part 9a along the axial direction. The front part of the cylindrical leg part 9b of the resin cover case 9 is inserted into the inside of the cylindrical frame 8 through the opening part thereof. This opening part of the cylindrical frame 8 is open toward the other side of the cylindrical frame 8. The resin cover case 9 is fixed to the cylindrical frame 8 so that the end part of the cylindrical frame 8 is caulked at the step part formed on the outer circumferential surface of the leg part 9b of the resin cover case 9. Further, the front end surface of the leg part 9b of the resin cover case 9 is in contact with the surface of the magnetic plate 27 at the side which is opposite to the second coil 12 side, and is positioned to the magnetic plate 27 in the axial direction. Further, an O-ring 30 made of resin is fitted to a groove which is formed on the outer circumferential surface of the leg part 9b of the resin cover case 9. An O-ring is a packing or a toric joint. The presence of such O-ring makes it possible to make a sealed space between the resin cover case 9 and the cylindrical frame 8 and to prevent outside water from being entering into the inside of the electromagnetic switch device 1

The one of the bolts 28 and 29 is a B terminal bolt connected to a high voltage side (to a battery side) of the starter motor circuit, and the other bolt is a M terminal bolt connected to a low voltage side (to the starter motor 3 side). Penetration holes (or through holes) are formed along the axial direction in the base part 9b of the resin cover case 9. Accordingly, the resin cover case 9 is tightly fixed to the cylindrical frame 8 with caulking washers 31 through the penetration holes by using the B terminal bolt and the M terminal bolt.

Fixed contact pair 32 and a single movable contact 33 are placed in the inside of the resin cover case 9. The fixed contact pair 32 and the movable contact 33 make the main switch, as previously described.

The fixed contacts 32 forming the pair are electrically and mechanically connected to the terminal bolts 28 and 29, respectively. That is, the fixed contacts 32 forming the pair are the different members from the B terminal bolt and the M terminal bolt. For example, a circular hole is formed in each of the fixed contacts 32, and the front part of each of the terminal bolts 28 and 29 is press-fitted into the inside of the corresponding circular hole.

Still further, as shown in FIG. 1, it is possible to form a serration on the surface below the head part of each of the terminal bolts 28 and 29. In this structure, the surface part on which the serration is formed is press-fitted into the circular hole of the fixed contact 32 in order to fix the terminal bolt to the fixed contact 32.

It is possible to form the two terminal bolts 28, 29 and the pair of the fixed contacts 32 by using different metal materials. For example, the fixed contacts 32 are made by copper material with a high conductivity. On the other hand, the two terminal bolts 28, 29 are made by using iron material having a high mechanical strength. Further, it is possible that the surface of the terminal bolts 28, 29 made of iron material is coated with copper by copper plating. This structure makes it possible to increase the electric conductivity of the terminal bolts 28, 29 in addition to having the mechanical strength because the surface of the terminal bolts 28, 29 is coated with copper by copper plating. Further, it is also possible to assemble the fixed contacts 32 and the terminal bolts 28, 29 to a single body. For example, the head part of each of the terminal bolts 28, 29 can be used instead of the fixed contact 32.

The movable contact 33 is supported by a shaft 34 made of resin which is fixed to the movable iron core 24. The movable contact 33 is positioned opposite to the side of the movable iron core 24 (at the right side in FIG. 1) when observed from the pair of the fixed contacts 32. Further, the movable contact 33 is pressed to the end surface of the shaft 34 by the pressing load generated by a pressure contact spring 35.

It is designed in advance that an initial load of the pressure contact spring 35 is smaller than that of the return spring 25. Accordingly, when no current flows in the second coil 12, because the movable contact 33 presses the pressure contact spring 35, the pressure contact spring 35 is compressed and pressed to the end surface of an inner convex part 9c which is formed on the base part 9a of the resin cover case 9 (as designated the condition shown in FIG. 1).

The main switch is turned on when the movable contact 33 is moved to and is in contact with the pair of the fixed contacts 32 after the pressure contact spring 35 presses the movable contact 33. The main switch is turned off when the movable contact 33 is separated from the pair of the fixed contacts 32 and the electrical connection between the movable contact 33 and the pair of the fixed contacts 32 is interrupted.

A description will now be given of the operation of the electromagnetic switch 1 according to the first exemplary embodiment when the internal combustion engine starts.

In the electromagnetic switch 1 according to the first exemplary embodiment, an idling stop electric control unit (an idling stop ECU) controls the primary solenoid SL1 and the secondary solenoid SL2 independently. Thus, the idling stop ECU acts as a control device. The idling stop ECU receives through an engine ECU (omitted from drawings) various types of control signals such as a detection signal indicating a rotation speed of the internal combustion engine, a detection signal indicating a position of a transmission shift lever (or a shift gear lever), and a detection signal indicating a turned-on or turned-off of the brake switch. The engine ECU controls the condition of the internal combustion engine. The idling stop ECU detects whether or not an engine stop condition is satisfied on the basis of the received detection signals. The engine stop condition is used to stop the internal combustion engine. When the detection result of the idling stop ECU indicates that the engine top condition is satisfied, the idling stop ECU generates and transmits an engine stop signal to the engine ECU. In addition, the idling stop ECU judges that an engine restart condition is satisfied when the driver of the motor vehicle operates to restart the internal combustion engine, for example, when the driver releases his foot from the brake pedal or the deriver operates the gear shift lever to the drive gear position during the idling stop condition in order to complete the idling stop and to restart the internal combustion engine.

When detecting the satisfaction of the engine restart condition, the engine idling stop ECU generates and transmits an engine restart request signal to the engine ECU, and generates and transmits a turning-on signal to the electromagnetic switch 1.

A description will now be given of the action of the electromagnetic switch 1 when the engine restart request is generated during the engine deceleration and stop period in which the rotation speed of the internal combustion engine is gradually decreased until the internal combustion engine is completely stopped.

The idling stop ECU generates and transmits a turning-on signal to the primary solenoid SL1 when the engine restart request is generated during the engine deceleration and stop period. A current is thereby supplied from the battery to the primary solenoid SL1 through a starter relay (not shown). This makes it possible to attract the plunger 16 to the magnetized iron core part 13b. During the movement of the plunger 16, the drive pinion 6 is pressed through the shift gear lever 10 toward the direction which is opposite to the starter motor 3 side. The end surface of the drive pinion 6 is in contact with the end surface of the ring gear 20. At this time, the rotation of the internal combustion engine is not completely stopped, that is, because the ring gear 20 is still rotated while decreasing the rotation speed thereof. Accordingly, when the rotation speed of the ring gear 20 is decreased to a predetermined speed at which the ring gear 20 can be smoothly engaged with the drive pinion 6, the pressure force accumulated in the drive spring 21 presses the drive pinion 6 to the ring gear 20. This makes it possible to engage the drive pinion 6 with the ring gear 20 correctly.

The idling stop ECU generates and transmits a turning-on signal to the secondary solenoid SL2 after an elapse of a predetermined period (for example, within a range of 30 ms to 40 ms) counted from the time when the idling stop ECU transmits the turning-on signal to the primary solenoid SL1. This makes it possible to supply a current from the battery to the second coil 12 through the starter relay (not shown). When receiving the current, the second coil 12 is magnetized, and the movable iron core 24 is attracted to the magnetized iron core part 13b. During the movement of the movable iron core 24, the movable contact 33 is forcedly pressed by the pressure contact spring 35, and is in contact with the pair of the fixed contacts 32. This makes it possible to close the main switch. That is, the starter motor 3 receives electric power supplied from the battery, and starts to rotate. The rotation power of the starter motor 3 is transmitted to the output shaft 4, and to the drive pinion 6 through the clutch 5. Because the drive pinion 6 has already been engaged with the ring gear 20, the rotation power of the starter motor 3 is transmitted to the internal combustion engine. The internal combustion engine is thereby cranked.

### (Effects of the Electromagnetic Switch 1)

The electromagnetic switch 1 having the above structure according to the first exemplary embodiment has the following features and actions.

In the improved structure of the electromagnetic switch 1 according to the first exemplary embodiment, the primary solenoid SL1 is accommodated in the cylindrical frame 8 at the mounting surface 8a side thereof. The secondary solenoid SL2 is accommodated in the cylindrical frame 8 at the cover side thereof. That is, the primary solenoid SL1 is arranged in the zone near the mounting surface 8a of the cylindrical frame 8 which is fixed to the starter housing case 7. On the other hand, the secondary solenoid SL2 is arranged in the zone which is apart from the mounting surface 8a of the cylindrical frame 8. It is therefore necessary for the second solenoid SL2 to have a measure to prevent heat energy generated in the second coil 12.

In the improved structure of the electromagnetic switch 1 according to the first exemplary embodiment, the magnetic plate 27 and the bobbin 23 of the second coil 12 are assembled as one body by a method such as insert molding. The magnetic plate 27 forms a part of the magnetic circuit of the secondary solenoid SL2. Further, the outer circumferential surface of the magnetic plate 27 is fitted to and adhered to in full contact with the inner circumferential surface of the cylindrical frame 8. As shown in FIG. 3, because this improved structure makes it possible to transmit heat energy generated in the second coil 1 12 to the magnetic plate 27, it is possible to discharge the heat energy to the cylindrical frame 8 made of metal through the magnetic plate 27 with high efficiency.

The mounting surface 8a formed at one end part of the cylindrical frame 8 along the axial direction, as shown in FIG. 2, is tightly fitted to the end surface of the starter housing case 7 having a large heat capacity. This makes it possible to discharge heat energy of the cylindrical frame 8 to the starter housing case 7. As a result, because the heat energy generated in the second coil 12 is easily transmitted through the pass composed of the bobbin 23, the cylindrical frame 8 and the starter housing case 7, this structure makes it possible to suppress the temperature of the second coil 12 from being increased.

In particular, the second coil 12 in the electromagnetic switch 1 has the improved structure in which the side surface area of the second coil 12 in contact with the flange parts 23b and 23c of the bobbin 23 is larger than the inner circumferential surface area of the second coil 12 in contact with the outer circumferential surface of the cylindrical body part 23a of the bobbin 23.

Because the magnetic plate 27 and the bobbin 23 made of resin are assembled as one body by insert molding, there is difficult to form a clearance or an air layer between the magnetic plate 27 and the flange part 23c of the bobbin 23 supporting the side surface of the second coil 12. In other words, the flange part 23c of the bobbin 23 is adhered to in full contact with the magnetic plate 27 without through any air layer. This makes it possible to keep a large cross sectional area of the heat energy transmission path from the axial end part of the second coil 12 to the magnetic plate 27 through the flange part 23c of the bobbin 23. It is therefore possible to transmit heat energy generated in the second coil 12 from the bobbin 23 made of resin to the magnetic plate 27 with high efficiency.

Because the improved structure of the electromagnetic switch 1 according to the first exemplary embodiment can discharge heat energy generated in the second coil 12 to the starter housing case 7 with high efficiency, it is possible to suppress the temperature of the second coil 12 form being increased.

FIG. 4 is a graph showing a comparison result of temperature rise between the electromagnetic switch device 1 according to the exemplary embodiment of the present invention and a conventional electromagnetic switch device. That is, FIG. 4 shows the detection results regarding the temperature rise of the electromagnetic switch 1 according to the first exemplary embodiment and an electromagnetic switch having a conventional structure. The comparison example shown in FIG. 2 shows the detection results of temperature rise of the second coil 12 after the elapse of ten minutes after the start of supplying a voltage of 12V to the second coil 12.

The magnetic plate in the conventional sample was made by punching by a usual press machine. Further, the magnetic plate is inserted into the inside of the cylindrical frame 8 with a clearance or gap. That is, the structure of the conventional sample has the outer circumferential surface of the magnetic plate 27 which is not adhered to in full contact with the inner circumferential surface of the cylindrical frame 28.

As clearly understood from the comparison result shown in FIG. 4, the temperature of the second coil 12 in the electromagnetic switch 1 according to the first exemplary embodiment was increased to approximately 270° C. On the other hand, the electromagnetic switch 1 having the conventional structure was increased to approximately 310° C. Therefore, the structure of the electromagnetic switch 1 according to the first exemplary embodiment has a low rate of increasing the temperature of the second coil 12. That is, a difference in temperature rise of the second coil between the electromagnetic switch 1 according to the first exemplary embodiment and the comparison sample is approximately 40° C.

Therefore it is possible for the structure of the electromagnetic switch 1 according to the first exemplary embodiment to discharge heat energy generated in the second coil 12 to the starter housing case 7 with high efficiency. This structure of the electromagnetic switch 1 can suppress the temperature rise of the second coil 12. This makes it possible to decrease the entire size of the second coil 12 and also possible to decrease the axial direction of the second coil 12. It is therefore possible to decrease the entire length of the electromagnetic switch 1 according to the first exemplary embodiment.

### Second Exemplary Embodiment

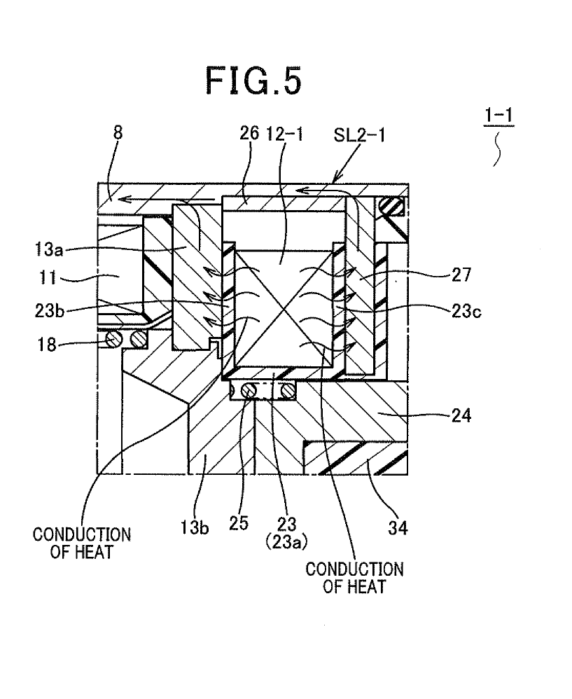

A description will be given of the electromagnetic switch 1 according to a second exemplary embodiment of the present invention with reference to FIG. 5.

FIG. 5 is a view showing a cross section of the second coil 124 of the secondary solenoid SL2-1 in the electromagnetic switch device 1-1 according to a second exemplary embodiment and showing the flow of heat (or a conduction of heat) generated in the second coil 12. In the structure of the electromagnetic switch 1-1 according to the second exemplary embodiment shown in FIG. 5, the bobbin 23 of the second coil 12 is arranged adjacent to the iron core plate 13a. In this structure, the flange part 23b of the bobbin 23 is arranged adjacent to the ring-shaped iron core plate 13a and arranged opposite to the resin cover case 9 side. As shown in FIG. 5, because the axial side surface of the flange part 23b of the bobbin 23 is adhered to in full contact with the surface of the ring-shaped iron core plate 13a, it is possible to transmit heat energy generated in the second coil 12 to the ring-shaped iron core plate 13a in addition to the magnetic plate 27 which is assembled with the bobbin 23 together by insert molding. Because the radius outer circumferential surface of the ring-shaped iron core plate 13a is adhered to in full contact with the inner circumferential surface of the cylindrical frame 8, like the case of the magnetic plate 27 and because the ring-shaped iron core plate 13a has a large thickness when compared with the axial thickness of the magnetic plate 27, it is possible to have a large contact area between the ring-shaped iron core plate 13a and the cylindrical frame 8.

The structure of the electromagnetic switch 1-1 according to the second exemplary embodiment makes it possible to discharge heat energy generated in the second coil 12 to the cylindrical frame 8 through the magnetic plate 27 and the ring-shaped iron core plate 13a. This can further suppress the temperature of the second coil 12 from being increased.

### (Modifications)

In the structure of the electromagnetic switch 1 according to the first exemplary embodiment, the magnetic plate 27 and the bobbin 23 are assembled together as one body by insert molding. The concept of the present invention is not limited by this structure. For example, it is sufficient for the electromagnetic switch 1 to have a structure in which the magnetic plate 27 is arranged adjacent to the bobbin 23 at an axial direction of the resin cover case 9 side and the outer circumferential surface of the magnetic plate 27 is adhered to in full contact with the inner circumferential surface of the cylindrical frame 8. The adhesion state means that the surface of the flange part 23c of the bobbin 23 is in full contact with the surface of the magnetic plate 27 without any clearance or gap.

The first exemplary embodiment previously described shows the case in which the engine restart request is generated during the period of gradually decreasing the rotation speed of the internal combustion engine after the idling stop request is generated. Because the primary solenoid SL1 and the secondary solenoid SL2 are independently controlled, it is possible to apply the electromagnetic switch 1 when the internal combustion engine is restarted after the complete engine stop by the idling stop request.

### (Features and Actions of the Present Invention)

The electromagnetic switch 1 for use in the starter motor 3 according to the exemplary embodiment, as previously described in detail, has the cylindrical frame 8, the resin cover case 9 and the solenoid unit. The cylindrical frame 8 is made of metal and has the mounting surface 8a at one axial end part of the cylindrical frame 8 and an opening part at the other axial end surface of the cylindrical frame 8. The mounting surface 8a is mounted to the starter housing case 7. The resin cover case 9 is mounted to and fixed to the opening part of the cylindrical frame 8. The cylindrical frame 8 is closed by the resin cover case 9. The solenoid unit has the primary solenoid SL1 and the secondary solenoid SL2. The primary solenoid SL1 has the first coil 11 which is magnetized when a current flows in the first coil 11. The magnetized first coil 11 attracts the drive pinion 6 to the ring gear 20 of the internal combustion engine side. The secondary solenoid SL2 has the second coil 12 magnetized when a current flows in the second coil 12. The secondary solenoid SL2 turns on and off a main switch in order to allow and inhibit a current to flow in the starter motor 3 according to an excitation state of the second coil 12. In the electromagnetic switch 1, the primary solenoid SL1 is arranged in the cylindrical frame 8 at the mounting surface 8a side of the cylindrical frame 8. The secondary solenoid SL2 is arranged in the cylindrical frame 8 at the resin cover 9 side so that the primary solenoid SL1 and the secondary solenoid SL2 are arranged in series along an axial direction of the electromagnetic switch 1, and assembled as one body. The secondary solenoid SL2 has the magnetic plate 27 made of metal which forms a part of a magnetic circuit and is arranged adjacent to the resin cover 9 side in the axial direction of the bobbin 23 made of resin on which the second coil 12 is wound, and the magnetic plate 27 is arranged to be perpendicular to the axial direction of the second coil 12. As shown in FIG. 1 and FIG. 2, the outer circumferential surface of the magnetic plate 27 in the radial direction is adhered to in full contact with the inner circumferential surface of the cylindrical frame 8.

In the structure of the electromagnetic switch 1 according to the exemplary embodiment, the primary solenoid SL1 is accommodated at the mounting surface 8a side of the cylindrical frame 8, and the secondary solenoid LS2 is accommodated at the resin cover case 9 side in the cylindrical frame 8. Because the secondary solenoid LS2 is arranged apart from the mounting surface 8a side of the cylindrical frame 8 which is fixed to the starter housing case 7, it is necessary to have a measure to discharge heat energy generated in the second coil 12.

In order to solve this problem, the magnetic plate 27, which is made of metal and forms a part of the magnetic circuit, is arranged adjacent to the bobbin 23 of the second coil 12, and the outer circumferential surface of the magnetic plate 27 is adhered to in full contact with the inner circumferential surface of the cylindrical frame 8. This improve structure makes it possible to transmit a large amount of heat energy generated in the second coil 12 to the magnetic plate 27 adhered to in full contact with the bobbin 23 and to discharge the heat energy generated in the second coil 12 to the cylindrical frame 8 made of metal through the magnetic plate 27 with high efficiency.

Further, because the mounting surface 8a formed at one axial end of the cylindrical frame 8 is adhered and fixed to the end surface of the starter housing case 7 having a large heat capacity, this can allow heat energy to be easily discharged from the cylindrical frame 8 to the starter housing case 7. As a result, it is possible to easily discharge heat energy generated in the second coil 12 to the starter housing case 7 with high efficiency. This can suppress temperature rise of the second coil 12, and decrease the total size of the second coil 12. Still further, because this structure can decrease the axial length of the second coil 12, it is possible to decrease the entire size of the electromagnetic switch 1.

In the electromagnetic switch 1, the magnetic plate 27 and the bobbin 23 made of resin are assembled together as one body by insert molding. In general, because a thermal conductivity of resin material is lower than that of metal material such as iron and aluminum, it is necessary to consider the thermal conduction from the bobbin 23 made of resin to the magnetic plate 27 made of metal.

In the structure of the electromagnetic switch 1 according to the exemplary embodiment, because the magnetic plate 27 and the bobbin 23 made of resin are assembled together with one body by insert molding, the flange part 23e of the bobbin 23 is adhered to in full contact with the magnetic plate 27, and there is no clearance or air layer in the contact surface between the flange part 23c of the bobbin 23 and the magnetic plate 27 (see FIG. 3). In other words, the surface of the flange part 23e of the bobbin 23 is adhered to in full contact with the surface of the magnetic plate 27 without any clearance or air layer. This structure allows heat energy generated in the second coil 12 to be discharged from the bobbin 23 side to the magnetic plate 27 with high efficiency, and suppresses the temperature rise of the second coil 12.

In the electromagnetic switch 1, the bobbin 23 made of resin has the cylindrical body part 23a and the pair of the flange parts 23b and 23c. The second coil 12 is wound around the cylindrical body part 23a. The pair of the flange parts 23b, 23c is formed at axial end parts of the cylindrical body part 23a. A side surface area of the second coil 12 observed along the axial direction of the bobbin 23 in contact with the flange parts 23b, 23c is larger than a surface area of an inner radius side of the second coil 12 in contact with the outer circumferential surface of the cylindrical body part 23a.

Because this structure can have a large cross sectional area of a thermal transmission path from the axial end part of the second coil 12 to the magnetic plate 27 through the flange part 23c of the bobbin 23, it is possible to further suppress the temperature rise of the second coil 12.

In the electromagnetic switch 1, the solenoid unit has the common stationary core 13 which forms a part of the magnetic circuit and is placed perpendicular to the axial direction of the first coil 11 and the second coil 12. The outer circumferential surface of the common stationary core 13 is adhered to in full contact with the inner circumferential surface of the cylindrical frame 8. The bobbin 23 made of resin, on which the second coil 12 is wound, is positioned adjacent to the common stationary core 13.

The magnetic plate 27 is arranged at the resin cover 9 side observed along the axial direction from the bobbin 23 (on which the second coil 12 is wound), and the ring-shaped iron core plate part 13a is arranged at the mounting surface 8a side of the cylindrical frame 8 which is opposite to the resin cover 9 side along the axial direction of the electromagnetic switch 1. Accordingly, this structure makes it possible to transmit heat energy generated in the second coil 12 to the ring-shaped iron core plate part 13a in addition to the magnetic plate 27. because the outer circumferential surface of the ring-shaped iron core plate part 13a is adhered to in full contact with the inner circumferential surface of the cylindrical frame 8, it is possible to discharge heat energy generated in the second coil 21 to the outside through both the directions, the magnetic plate 27 side adjacent to the bobbin 23 and the ring-shaped iron core plate part 13a side. This makes it possible to suppress temperature of the second coil 12 from being increased with high efficiency.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. An electromagnetic switch for use in a starter motor comprising:
a cylindrical frame made of metal having a mounting surface at one axial end part of the cylindrical frame and an opening part at the other axial end surface of the cylindrical frame, the mounting surface being mounted to a starter housing case;
a resin cover mounted to and fixed to the opening part of the cylindrical frame in order to close the cylindrical frame; and
a solenoid unit comprising a primary solenoid and a secondary solenoid, the primary solenoid comprising a first coil magnetized when a current flows in the first coil, and the magnetized first coil attracts a drive pinion to a ring gear of an internal combustion engine side, and the secondary solenoid comprising a second coil magnetized when a current flows in the second coil, and the secondary solenoid turning on and off a main switch in order to allow and inhibit a current to flow in a starter motor according to an excitation state of the second coil,
wherein the primary solenoid is arranged in the cylindrical frame at the mounting surface side of the cylindrical frame, and the secondary solenoid is arranged in the cylindrical frame at the resin cover side so that the primary solenoid and the secondary solenoid are arranged in series along an axial direction of the electromagnetic switch, and assembled as one body,
the secondary solenoid has a magnetic plate made of metal which forms a part of a magnetic circuit and is arranged adjacent to the resin cover side in the axial direction of the bobbin made of resin on which the second coil is wound, and the magnetic plate is arranged to be perpendicular to the axial direction of the second coil, and the outer circumferential surface of the magnetic plate in the radial direction is adhered to in full contact with the inner circumferential surface of the cylindrical frame.

2. The electromagnetic switch according to claim 1, wherein the magnetic plate and the bobbin made of resin are assembled together as one body by insert molding.

3. The electromagnetic switch according to claim 1, wherein the bobbin made of resin comprises a cylindrical body part and a pair of flange parts, the second coil is wound around the cylindrical body part, and the pair of the flange parts are formed at axial end parts of the cylindrical body part, and
a side surface area of the second coil observed along the axial direction of the bobbin in contact with the flange parts is larger than a surface area of an inner radius side of the second coil in contact with the outer circumferential surface of the cylindrical body part.

4. The electromagnetic switch according to claim 1, wherein the solenoid unit comprises a common stationary core which forms a part of the magnetic circuit and is placed perpendicular to the axial direction of the first coil and the second coil, an outer circumferential surface of the common stationary core is adhered to in full contact with the inner circumferential surface of the cylindrical frame, and the bobbin made of resin, on which the second coil is wound, is arranged adjacent to the common stationary core.

5. The electromagnetic switch according to claim 4, wherein the common stationary core comprises a ring-shaped iron core plate part and an iron core part, and an outer circumferential surface of the ring-shaped iron core plate part is adhered to in full contact with the inner circumferential surface of the cylindrical frame, the common stationary core is placed between the first coil and the second coil, the iron core part is pressed into and fitted to the inner circumferential part of the ring-shaped iron core plate part, an outer circumferential surface as one end part of the ring-shaped iron core plate part is in contact with a step part formed in the inner circumferential surface of the cylindrical frame so that the ring-shaped iron core plate part is placed against the mounting surface of the cylindrical frame, and the bobbin is arranged adjacent to the iron core part in the secondary solenoid.

6. The electromagnetic switch according to claim 4, wherein one end surface along the axial direction of the bobbin is adhered to in full contact with the magnetic plate, and the other end surface along the axial direction of the bobbin is adhered to in full contact with the ring-shaped iron core plate part.
